(19) United States
(12) Patent Application Publication
(10) Pub. No.: US 2026/0357693 A1
(43) Pub. Date: Nov. 12, 2026

(54) SOFTWARE, DATA ACQUISITION, AND CONTROL OF A FLUID PRESSURE ELECTRICITY PRODUCTION FACILITY

(71) Applicant: Quidnet Energy Inc., Houston, TX (US)

(72) Inventors: Bunker Hill, Sugar Land, TX (US); Dagong Zhou, Houston, TX (US); Scott Wright, Houston, TX (US); Henry Lau, Houston, TX (US); Howard K. Schmidt, Hockley, TX (US)

(21) Appl. No.: 19/055,719

(22) Filed: Feb. 18, 2025

Related U.S. Application Data
(60) Provisional application No. 63/645,853, filed on May 11, 2024.

(51) Int. Cl. E21B 47/003; E21B 43/12; F03B 13/02

(52) U.S. Cl. CPC E21B 47/003; E21B 43/129; F03B 13/02

(57) ABSTRACT

The present invention explains methods for software and control to perform tasks automating the amount of energy stored, the charge rate, discharge rate, and the financial impacts of a geomechanical energy storage system where the elasticity of the rock and the overburden of the earth are used to maintain pressure on the high pressure, fluid storage volume.

### CROSS-REFERENCE TO RELATED APPLICATION

This application claims the benefit of U.S. Provisional Patent Application No. 63/645,853 filed May 11, 2024, which is hereby incorporated by reference in its entirety herein.

### BACKGROUND OF THE INVENTION

### I. Field of the Invention

The present disclosure relates generally to software, data acquisition, and control methods relating to geomechanical, subterranean energy storage and the ability to produce useful work and generate electricity.

### II. Description of the Prior Art

Energy storage is needed to balance the large variations in supply and demand to supplement the power generation systems currently in use. High summer temperatures, low winter temperatures, electric powered transportation methods, artificial intelligence (AI) data methods and the like are adding to the power needs of today. Large scale energy storage methods currently include compressed air energy storage (CAES), natural gas cavern storage, pumped hydro, chemical batteries, and geomechanical energy storage. Each energy storage system uses different physics and mechanics to achieve the goal of providing energy when it is needed in sufficient quantity. Underground, cavern, natural gas storage is popular in Europe and other places around the world to store chemical energy until it is needed in the long heating season.

CAES relies on the elasticity of the working fluid and the thermal expansion of the working fluid at the surface to produce useful work. Accordingly, for hydraulic systems like CAES, PE (potential energy)=(1/2) kx², where: PE is the elastic potential energy (measured in joules, J) k is the spring constant (measured in newtons per meter, N/m) and x is the displacement from the equilibrium position (measured in meters, m).

Pumped hydro is the method of storing energy by pumping water to a higher elevation, storing it, then later allowing the water to fall under gravitational forces to spin a turbine/generator combination to produce electricity. Water is pumped up the hill during off-peak demand periods when electricity is available at a lower cost. For pumped hydro, (potential energy)=mass of water (m)×gravitational acceleration (g)×height difference (h).

Geomechanical energy storage is similar to compressed air energy storage (CAES) in that the working fluid is stored underground, however the energy recovery mechanisms are quite different. Both systems can gain some geothermal energy from the earth to warm the working fluid but geomechanical energy storage relies on the elasticity of the earth and the overburden on the rock where the working fluid is stored.

In the construction phase of the geomechanical energy storage system the well, the subterranean zone, and the surface facilities must be built and/or properly prepared for the operation phase. A subterranean zone can be made up of man-made hydraulic fractures, natural fractures, natural occurring caves, or other fluidically connected geologic features. Not all geomechanical systems include fractured formations in the subterranean zone. Some are well sealed and do not require hydraulic fracturing or sealing.

For this technology any or all fluidically connected parts can be used to store high pressure fluid. The fluid stored may be used as the working fluid for a system to produce electricity or other useful work below ground or above ground.

The steps to prepare the zone, fracture, store high pressure fluid in the subterranean zone, and then move it to the surface equipment to perform useful work, desalinate water and generate electricity are described in applicant's earlier granted patents, U.S. Pat. Nos. 8,763,387, 9,481,519, 10,125,035 and 11,927,085, all of which are hereby incorporated by reference in their entirety herein. Also hereby incorporated in their entirety herein are applicants'U.S. Pat. No. 11,795,802 describing the creation of fractures in the subterranean zone, sealing it, and preparing it to store high-pressure working fluids which are later moved to the surface to perform useful work; and U.S. Pat. No. 12,123,293 describing other methods to fracture and seal the subterranean zone prior to utilizing it for storage of the high-pressure working fluid.

Essentially, the first step is to collect and evaluate geologic data. Pilot wells may be drilled to collect various geologic data including core samples to verify models. Once a feasible well placement has been determined, one or more wells are drilled, then one or more casing strings are run and cemented in place. Completions are designed and placed in a manner that allows the working fluid to traverse between the wellbore and subterranean formation with the least restriction. In some instances, it may be necessary to sever the upper casing from the lower casing. There are many methods available today to perform this operation which may include techniques such as perforating, fracturing, water jetting, or others to establish a smooth fluid flow path into and out of the subterranean zone for the working fluid through the wellbore.

After the well is constructed, pressure pumping and fluid mixing equipment are moved to the location. One or more treatment schedules are injected into the target subterranean formation to artificially modify the permeability of the formation. At this time the formation can be sealed and prepared for the operation phase.

During the operation phase, a working fluid is injected down the well bore, and out into the subterranean zone. Energy is stored in the subterranean zone as high-pressure fluid. Fluid is pumped from a low-pressure storage area to a high-pressure subterranean zone where it can be used immediately or stored for a period of time before being moved to the surface to produce useful work. The high-pressure fluid can, for example, be used with a turbine/generator set to produce electricity. Low-pressure storage can be a subterranean zone located close to the surface. One or more wells might be used in the geomechanical energy storage system. Some may be dedicated to injection or production flow, or a combination of these regimes depending on subterranean zone access and system demands. In any event, the fluid is stored there under pressure until all, or part of the fluid volume is returned to the surface. In most instances, this high-pressure fluid will be used to produce electricity.

Once such geomechanical energy storage facilities are constructed and operational, the stored energy can be released to produce workable energy, such as electricity. In order to convert this stored energy as efficiently as possible, a control system needs to be utilized. While there is a plethora of software and control systems currently in use for CAES, geothermal, hydroelectric, wind, solar, and chemical battery energy storge from sources like GE, Emerson, Eaton, Stem, JadeTrack, and others; none of these systems currently have all the features necessary for the efficient control of geomechanical energy storage systems.

One such efficiency is with respect to price arbitration. When electric energy is time shifted, it is known as energy arbitration or price arbitration. It is the practice of using electricity during off-peak, lower price to store energy which can be released during peak, higher price periods to maximize energy availability. This can be done with geomechanical energy storage, compressed air energy storage (CAES), chemical batteries, pumped hydro and other types of energy storage. The ability to use a control system in this type of situation would be most beneficial.

Another such efficiency is with respect to electric grids and how the stored energy may be integrated therein. Other issues/problems associated with stored energy and the efficiency thereof include generation characteristics such as energy storage degradation storage system round trip efficiency, the system's nameplate power rating, the maximum input power, the maximum output power, discharge duration, power discharge duration, reliability, storage response time, system inertia, ramp rate for power output, total amount of energy stored, and stored efficiency.

The present disclosure addresses and fulfills these needs. Accordingly, it is a general object of this disclosure to provide a control system used with geomechanical energy storage systems.

It is another general object of this disclosure to provide a data acquisition system used with geomechanical energy storage systems.

It is yet another general object of this disclosure to provide a geomechanical energy system that includes data acquisition components, software, algorithms, and control routines.

It is a more specific object of the disclosure to provide a geomechanical energy storage system that quantitatively measures energy.

It is another more specific object of the disclosure to provide a geomechanical energy storage system that calculates financials associated with the stored energy.

It is yet another more specific object of the disclosure to provide a geomechanical energy storage system that is automated.

These and other objects, features and advantages of this disclosure will be clearly understood through consideration of the following detailed description.

### SUMMARY OF THE INVENTION

According to an embodiment of the present disclosure, there is provided a system for operating energy stored using high-pressure fluid in a subterranean zone adapted to receive and retain the fluid in a generally sealed formation. The working fluid is supplied from a storage tank through a pumping facility into the zone. Software receives system data and calculates energy stored in the zone as well as an extractable amount of energy, and a control module converts the extractable energy to usable work.

According to an embodiment of the present disclosure, there is also provided a method for operating energy stored including adapting a zone to receive and retain the working fluid, supplying the fluid from a storage tank to the zone, obtaining data from the system, calculating an amount of energy stored in the zone as well as an amount of extractable energy, and converting the extractable energy to usable work

According to an embodiment of the present disclosure, there is also provided a module for operating energy stored using a high-pressure fluid in a subterranean zone using a data acquisition member to obtain data from the zone, the fluid and the pumping facility, and a software member using that data to calculate an amount of energy stored in the zone and an amount of lost energy, and a control member for converting the remaining extractable energy into usable work at the facility

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a simplified schematic view of a prior art geomechanical subterranean energy storage system.

FIG. 2 is a simplified schematic view of a geomechanical subterranean energy storage system according to the principles of an embodiment of the present disclosure showing a coupled data acquisition, software and/or control system.

FIG. 3 is a simplified schematic view of two geomechanical subterranean energy storage systems according to an alternate embodiment of the present disclosure utilizing a single coupled data acquisition, software and/or control system.

FIG. 4 is a simplified schematic view of two geomechanical subterranean energy storage systems according to an alternate embodiment of the present disclosure each utilizing their own data and data acquisition while tied to a single software and/or control system.

FIG. 5 is a block diagram showing a field of three geomechanical subterranean energy storage systems according to an alternate embodiment of the present disclosure utilizing a single data, data acquisition, software and/or control system.

FIG. 6 is a block diagram showing three geomechanical subterranean energy storage systems according to an alternate embodiment of the present disclosure utilizing their own data and data acquisition while all tied to a single software and/or control system.

FIG. 7 is a block diagram showing the feeding of data into a software and/or control system and providing an output according to the principles of an embodiment of the present disclosure.

FIG. 8 is a simplified schematic view of the geomechanical subterranean energy storage system of FIG. 1 including a fluid flow path.

FIG. 9 is a block diagram showing a fluid pumped into the zone and the energy gathered to produce output.

FIG. 10 is a block diagram showing the energy storage module including inputs feeding the finance and automation modules.

### DESCRIPTION OF THE PREFERRED EMBODIMENTS

One or more embodiments of the subject disclosure will now be described with the aid of numerous drawings. Unless otherwise indicated, use of specific terms will be understood to include multiple versions and forms thereof.

A typical geomechanical subterranean energy storage system is illustrated in the simplified schematic diagram of FIG. 1. Such a geomechanical subterranean energy storage system will also be referred herein as a geomechanical pumped storage (GPS) system. In any event, the GPS system 10 of FIG. 1 includes a well 12, a subterranean zone 14, a surface facility 16 and a mechanism 18 for working fluid storage. It will be appreciated that the single well 12 might be replaced with multiple wells with fluid communication features for different depths which may include fluid communication and control features for one or more subterranean zones 14. The single surface facility 16 may include equipment to generate electricity, or may include the equivalent equipment and/or machines to convert high pressure fluid flow to electricity. The single surface facility 16 might include one or more sets of equipment and/or machines to convert high pressure fluid flow to electricity. Each set might be sized for a different fluid profile, volume, or velocity. A surface facility 16 might be connected to adjacent surface facilities. Each set of equipment in the surface facility 16 might be sized, include control systems, or specific features to optimize flow rates or electricity output.

The working fluid storage 18 might be a surface pond, lake, tank, battery of tanks, subsurface formation, or any other suitable working fluid storage system. It may or may not include mineral capture sub-systems.

One or more geomechanical pumped storage (GPS) systems 10 might be linked together. A field of several geomechanical pumped storage systems might be connected together to maximize up time, minimize down time, or otherwise optimize fluid flow and/or electricity output.

The geomechanical pumped storage (GPS) systems 10 might be different sizes depending on the available surface area, working fluid storage type or volume, or the subterranean zone capacity, or the electricity supply requirements. The efficiency and optimization might be based on working fluid type, flow rate, surface equipment match up, run time, subterranean zone(s) size, pressure, and/or flow rate.

Each geomechanical pumped storage (GPS) system might have different features, for example: electricity supply size; available surface area; working fluid type, chemical composition, solids content, volume; subterranean zone (one or more), depth, working fluid compatibility, volume, pressure, volumetric flow rate; and/or other design characteristics, capacities, or limitations.

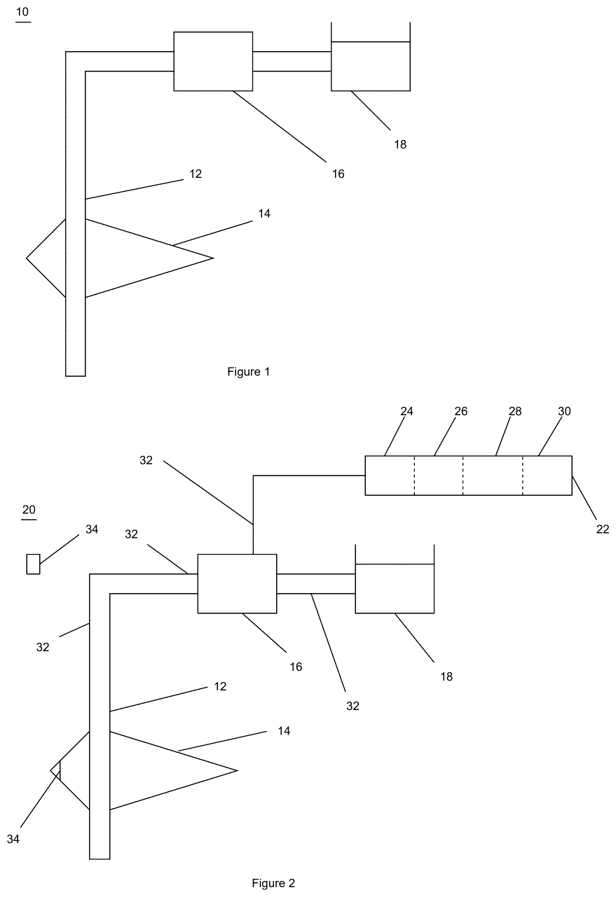

Turning now to a preferred embodiment of the present disclosure, and in particular FIG. 2. This GPS 20 includes a well 12, a subterranean zone 14, a surface facility 16, a mechanism 18 for working fluid storage, and a data, data acquisition, software and/or control system 22. Such a data 24, data acquisition 26, software 28 and/or control 30 system 22 may also be referred to herein as modules each of which may include its own processor. It will be understood that communications, data, control, etc. is seamlessly transmitted between and through each of the coupled 32 component parts of this GPS 20. In other words, and by way of example, data 24 can be acquired 26 from the subterranean zone 14 and communicated 32 through the surface facility 16 to the control system 22. Such communication protocols are well known in the art.

Data can be gathered by the data acquisition 26 module during the construction phase and can be used to update the mathematical model and software control system to optimize the fluid pressure and volume estimations for the storage subsystem. The data may also be used to estimate electrical production capacity, total fluid capacity, extent of leakage, fluid capacity remaining at any point in time, system inefficiencies, data irregularities, system set points, indicators, flags, operating variations, and system limitations. The data may also be used for determining the layout and design of multiple wells operating in proximity to each other, including determining parameters such as inter-well spacing at surface, inter-well spacing underground, wellbore sizing and depth, wellbore casing program design, and so on.

Mathematical models and software 28 control systems 30 could be used to optimize the fluid pressure and volume estimations for the storage subsystem. As data is gathered, it is envisioned that it will be used to calibrate and refine the system controls, flow rates, electrical production rate vs. time curve and the like.

Tracking efficiency might include monitoring changes in flow rates, pressures, and variations in electrical output. An optimized control system 30 might include features for integration with other types of electricity production or storage facilities like CAES, battery, coal, wind, solar, natural gas, geothermal, etc. An overall software control system might use each of the facilities with on, off, mid-level output control to optimize available resources, financial gain, and/or high electrical demand. It could also be used to control, market timing, schedule delivery, minimize cost, and/or maximize electrical output.

The control system and manifolds may include features to bypass the surface turbine/generators in case the working fluid needs to be circulated independent of electricity production. This might be useful for working fluid maintenance, adding fluid additives, moving fluid to alternative surface storage locations, fluid conditioning, grid system response, safety response, etc.

The control system and manifolds might include features to feed alternative turbine/generators based on flow rate, size, market demand, local grid, national electric grid integration, etc. Tracking the data and performance of the subterranean zone will be known as the digital lens. The storage facility, a subterranean zone, can be modeled, controlled and optimized by gathering data, storing it, and analyzing it. Fluid retention, fluid input, fluid output, pressure, stress and strain responses, and temperature changes are just some of the operational characteristics which will be used to control and improve the operation of the subterranean zone and the overall system performance.

Tiltmeters 34 may be used to monitor the subterranean storage formation and/or working fluid. They can be installed near the surface or deeper below grade and are used to measure surface and/or subsurface motion induced by movement of fluids. They have been used in the past in the oil and gas industry to monitor fluid movement changes during hydraulic fracturing operations, determining direction of fracture propagation during hydraulic fracturing operations, tracking fracture progression in mining operations and seismic monitoring/prediction of volcanic activity.

The control system 22 could be a supervisory control and data acquisition (SCADA) system(s) used on just subsystems or in the overall control methodology of a subterranean fluid storage facility 20 used to produce electricity. Several sub systems might be combined. One or more wells might have access to one or more subterranean zones that hold working fluid under pressure. The method to optimize energy output might include flowing from one well near the center of a subterranean zone to reduce fluid friction, piping distance, etc. Also, wells might have completion or intervention equipment to assist with down hole flow control. These configurations might include on/off valves like sliding sleeves, fixed chokes, variable chokes, and the like. Sophisticated, feature rich completion strings with remote controls might be used to optimize fluid flow into or out of different zones with different pressure and volume capabilities.

The control system 22 for the subterranean energy storage facility used to produce electricity may make charging and discharge decisions based on market conditions (e.g., prices, forecasts), physical grid conditions (e.g., grid voltage, frequency), and/or energy levels within the subterranean zone(s).

The control system 22 for the subterranean energy storage facility used to produce electricity can, create a desirable “shape” for the charging/discharging power time-series curves based on market conditions (e.g., prices, forecasts), physical grid conditions (e.g., grid voltage, frequency), and/or energy levels within the subterranean zone(s).

The control system 22 for the subterranean energy storage facility used to produce electricity can, sequence how the pumps, turbines, and/or generators are turned on or off or otherwise operated. Variable frequency drives may be used or integrated.

Working fluids, fracturing fluids, or sealing fluids can be pumped into one or more subterranean zones. It can be stored or allowed to flow back immediately to produce electricity. If zone control methods are in place, other flow paths can exist including flow from one zone to another, and flow from one or more zones to surface.

All the data 24 gathered can be time stamped to conduct detailed analysis of events and anomalies. This learning process can be used in conjunction with the software 28 and control 30 system to set guidelines, operational limits, and optimize inputs and outputs.

The system 20 might include on, off, or mid-range control of flow rates through surface systems, well bores, completion strings, insert strings, down hole flow controls, and one or more subterranean zones.

All or part of the working fluid might be stored for a period of time, or it might be used immediately. The fluid can be pumped into one or more subterranean zones and be used to produce electricity at the same time. There might be an immediate need for electrical power.

Data 24 can be collected at any time before pumping, during pumping, during fluid storage or while flowing fluid out of a subterranean zone 14. Data 24 can be collected at any time during the working fluid cycle of injection, storage, or production. Injection is defined as pumping fluid from the low-pressure storage place, through the well 12 to the high-pressure, subterranean zone 14. Production flow is defined as fluid flow from the high-pressure, subterranean zone, up the well bore to the surface facilities 16 and then to the low-pressure storage place.

Data 24 can be collected from any point in the system. It may be at least one of: pressure, temperature, fluid composition, fluid flow rates, strain, seismic, tiltmeter, and/or direct or indirect geometric measurements. Also included are ground movement measurements which might be made with InSAR. Interferometric synthetic-aperture radar (InSAR) data might be collected, date and time stamped, stored, and used for analysis.

The software and control system 22 can determine and communicate the amount of energy contained in and extracted from the system at any time. The energy may be potential energy calculated with the fluid volume stored under pressure and/or geothermal energy gathered with the working fluid stored in the subterranean zone.

The software and control system 22 can determine and communicate the amount of energy contained in any subsystem. The system may contain one or more subterranean zones. The system may contain subterranean zones at different working fluid pressures and temperatures. The system may contain one or more well bores.

The software and control system 22 can determine and communicate the amount of energy contained in any subsystem. It can determine if more energy can be stored in any subsystem.

The software and control system 22 can determine and communicate how much energy can be extracted. This calculation may include the thermal energy gathered by the working fluid. That calculation will include the working fluid volume stored in the subterranean zone 14, its surface temperature, its subterranean temperature, the soak time, and the working fluid composition.

If the working fluid composition is changed at any time, the software and control system 22 can track that, record it, and adjust any calculation routine based on the changes. If there are chemical compatibility issues between two or more subterranean zones or different working fluid compositions the system can include features to track that and assist operators in keeping those fluid systems separated in the event of shared surface equipment, multiple well bores, and/or multiple subterranean zones.

The software and control system 22 can determine and communicate the pumping rate and/or production rate so as to minimize the degradation of the mechanical stability of the subterranean formation.

Some working fluids, fracturing fluids, or re-fracturing fluids may include some solids content. If the system includes one or more well bores, completion strings, and one or more subterranean zones, these sub systems may have limitations such as erosion, flow rate, pressure, chemical, material, or corrosion. The software and control system 22 could be used to minimize damage and maximize system life span and performance.

Once the fluid friction rates and parameters are established, the software and control system 22 could be used to monitor, estimate, inject friction reducing material, inject wettability modifying material, and inject corrosion inhibiting material to minimize damage and maximize system life span and performance.

Manual overrides for all system features will be designed in and implemented. These might include valves, chokes, on/off switches, pressure manifolds, or other electrical, fluid control, or mechanical systems, components and/or sub-systems.

Data 24 gathered during construction and/or operations phase used to update the mathematical model and software control system for making injection or production decisions so as to maintain a certain level of diffusion or equilibration of thermal energy (temperature), mechanical energy (pressure) and/or dissolved molecules (e.g, gas, salts) between the cycling fluid and the rest of the subterranean reservoir.

The software and control system 22 can control the pumps and the valves. It can determine where to pump the fluid and what composition goes to which low-pressure storage or high-pressure storage area. It can contain logic and contol to start, stop, or run pumps at different rates. The timing and the amount of fluid can be calculated and automated, controlled, and tracked.

These tasks can be performed for fluid storage as well as electricity generation, performing useful work or desalinating water. If the system contains enough pumps and valves, multiple operations can take place simultaneously. The software and control system 22 could determine, control and communicate multiple fluid flows into or out of different storage areas based on capacity and volume stored.

Surface ponds or tanks may include floats to assist the software and control system 22 in calculating volume for storage, pumping, mixing. These floats might also be used for fail safes, such as auto shut off.

The subterranean zone 14 may contain naturally fractured sections, a man-made fracture, a fracture network, or a porous reservoir. The subterranean zone 14 may or may not require that sealing materials be placed from time to time to limit leakage.

One or more subterranean zones 14 might be used. They might be used all at one time or in any combination. The fluid control systems might include down hole controls, surface controls or multiple well bores or any combination of these.

The software and control system 22 can determine, control and communicate a schedule for consuming electricity or other forms of energy. The software and control system 22 can determine, control and communicate when to add hydraulic and/or thermal energy to the working fluid in the subterranean zone. The software and control system 22 can determine, develop, control and communicate a schedule for generating electricity or other useful forms of energy extracted from the subterranean zone. The software and control system 22 can determine, control and communicate such schedules to the power grid or power generation operating and planning information systems.

The system could gather, generate, incorporate, calculate, or disseminate information comprising any of these: financial information about the local power grid or the national power grid including utility tariffs, commodity prices, electricity. The system could gather, generate, incorporate, calculate, or disseminate information about the power grid including actual supply & demand conditions, forecasted supply & demand conditions, planned outages of grid facilities or other generation facilities, weather, grid voltage, grid frequency. The system could gather, generate, incorporate, calculate, or disseminate information about the and the same financial and physical information regarding a specific energy consuming facility.

The software and control system 22 could develop a schedule for consuming electricity to add hydraulic and/or thermal energy to the subterranean formation. The software and control system 22 could develop a schedule for generating electricity from the hydraulic and/or thermal energy extracted from the subterranean formation. The software and control system 22 could communicate such schedules to the power grid or power generator operating and planning information systems.

The software and control system 22 could collect information and build a computational model that can be used to make determinations regarding other subterranean formations, including fractures, fracture networks, and porous reservoirs, based on formation and fluid properties including porosity, permeability, fluid composition, fluid rheology, fluid and rock compressibility's, water saturation, pore pressure, lithology, geochemistry, in-situ stress, depths, fracture geometry, and temperature.

The subterranean zones might be in the same vicinity, connected to the same well bore or they may be in the same field. The subterranean zones may or may not have formations with similar physical or operational characteristics. The subterranean zones and wells may be located a far distance apart.

The software, control system 22 and data 24 could be used to decide when and which remedial actions to improve, or slow down the degradation of the ability of the subterranean zone 14 to receive, store, and discharge hydraulic and/or thermal energy; where such remedial actions includes at least one of: injecting chemicals into the subterranean formation, altering one or more of the existing wellbores that are connected to the subterranean zone, and drilling additional wellbores into the subterranean formation.

The software and control system 22 could include software features to block the flow of data to outside sources. The software and control system 22 could include software features to send or receive selected data to outside sources. Outside sources might include other energy storage systems, local energy generation systems, SCADA (supervisory control and data acquisition) systems, local electricity generating systems, or the operating systems for any of these including the national electric grid.

The software and control system 22 may include information about failure modes, service life, cycle time, etc. This and other information might be incorporated in dashboards or simplified graphics that are easy to understand at a glance.

The software, control system 22 and the piping system can include provisions to allow some or all of the fluid moving from the subterranean zone to bypass the surface equipment used to produce electricity. These features might be useful during start up, full output mode, partial output mode, maintenance mode or shut down. The software, control system 22 and the piping system can include provisions to allow gather pressure and temperature data at: the wellbore formation interface; the wellhead; both upstream and downstream of the surface facility equipment converting high pressure fluid to electricity; any point of interest in the surface piping system; and any point of interest in the wellbore.

The working fluid level could be measured in each of the surface storage devices 18. The flow rate could be measured: at the wellbore formation interface; at the wellhead; both upstream and downstream of the surface facility equipment converting high pressure fluid to electricity; at any point of interest in the surface piping system; and at any point of interest in the wellbore. The data 24 measured could be time stamped and stored in one or more locations.

The software control system 22 might be connected securely to the internet with provisions to collect data, run in an automated mode, or in a manual mode, or in a semi-automated mode. The software control system 22 might be connected to the measurement, verification, settlement, billing, and/or invoicing systems of the power market(s) and/or the utility to which the geomechanical pumped storage is connected.

The software control system 22 can be used to monitor and control a single geomechanical pumped storage system, multiple geomechanical pumped storage system systems, or an entire network of geomechanical pumped storage systems.

System provisions, controls 30, and data 24 can be incorporated about any number of variables, including, but not limited to: weather; heat; cold; humidity; sunlight; day; night; rain; water run off; surface water capacity; air temperature; snow load; freezing water; freezing working fluid; heating surface plumbing at start up; surface turbine spin up; start up procedures; shut down procedures; cool down; geologic events; earthquake; high/medium/low electrical demand; high profit margin; aging systems; aging subsystems; maintenance needed on subsystems; large/small percentage of loss of working fluid; evaporation/theft/loss from surface pond; surface pond/tank level; surface pond/tank gas detection; working fluid composition and presence of solids or fines; loss to an underground thief zone; hole in the completion; inefficiencies such as increased fluid friction; cameras; automated lighting; microphones; speakers; intercom system; phone system; computer network; on site an doff site data storage; and security system components.

The software and control system 22 might be on site and might only be connected to national electrical grid power and run all the time or part of the time. The software control system 22 might be connected to a remote cloud server. The computer system might be configured to run on the local battery storage system stored with surface equipment or another locally supplied energy source.

The software and control system 22 may include controls to charge a battery bank as one of the geomechanical pumped storage systems produces electricity. The software control system may include controls to run an air compressor which has an air storage tank. The software and control system 22 might include a power conservation mode. The entire software and control system might run only when the system is producing electricity or parts of it may run all of the time. The software and control system 22 might incorporate chemical composition sensors at selected surface piping points.

The software and control system 22 might include features to control sequencing the start-up of a collection of subterranean zones and electrical generators such that the electrical transients induced on the grid during that start-up is within tolerance of the grid.

The software and control system 22 might include features to control the sequencing of how the pumps and/or turbines are turned on. The motor driving the pump and/or the generator might use Variable-Frequency Drive technology. (VFD). A VFD system controls the speed and torque by changing the frequency of the input.

When geomechanical energy storage systems are combined with software and control methods, they may be integrated with other electricity producing technologies such as: wind; solar; photovoltaic; lithium-ion battery storage; hydrogen, hydrogen fuel cell; coal; natural gas; hydroelectric; pumped water systems; geothermal; petroleum; oil-fired power plants; nuclear; biomass boiler type; CAES, and geomechanical pumped storage systems. Combining energy conversion types and/or energy storage methods may help to balance supply and demand. It may also be the only feasible, cost-effective way to meet demand during peak demand.

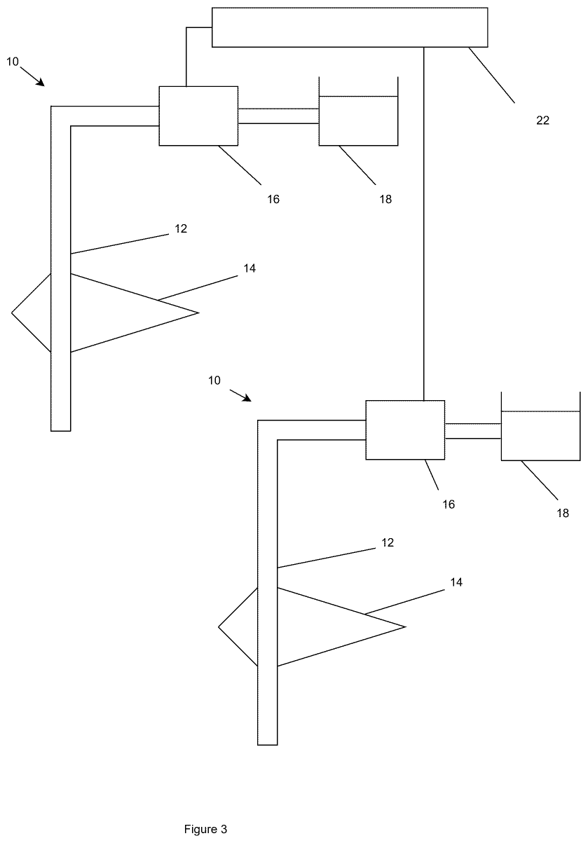

FIG. 3 shows two GPS systems 10 and one control system 22. The sub systems of each GPS 10 includes its own well 12, subterranean zone 14, service facility 16, and working fluid storage 18; while utilizing a shared control system 22.

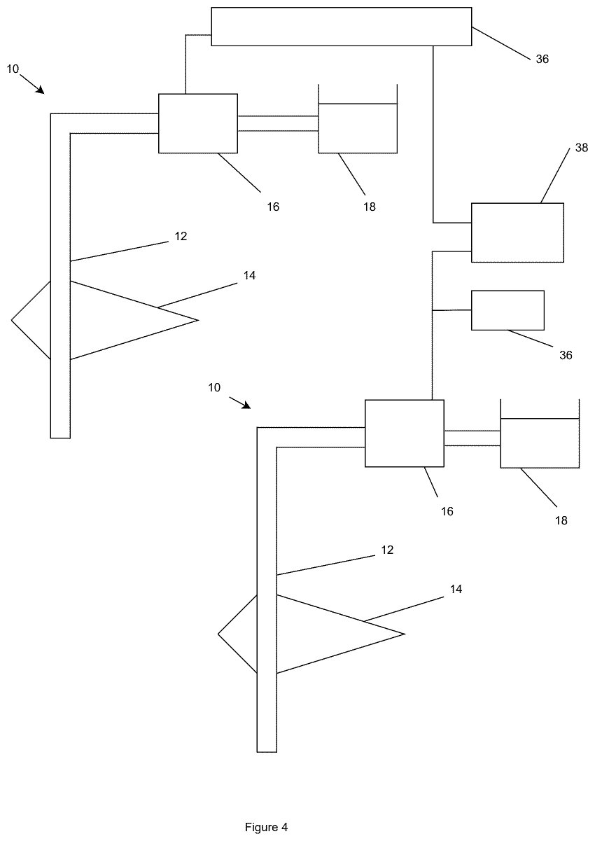

FIG. 4 shows two GPS systems 10 wherein each has its own data 24 and data acquisition 26 module 36 coupled to one software 28 and/or control system 30 module 38. The sub systems of each GPS 10 includes its own well 12, subterranean zone 14, service facility 16, working fluid storage 18, and data and data acquisition module 36; while utilizing a common software and/or control system module 38.

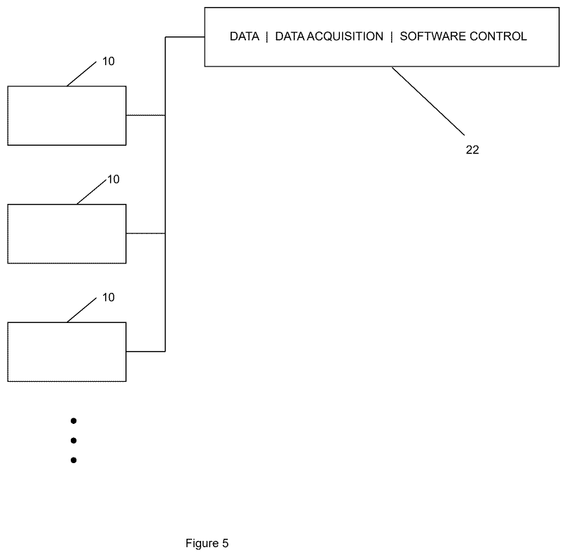

FIG. 5 shows a field of at least three GPS systems 10 all tied to a single data, data acquisition, software and/or control system 22. The configuration is similar to FIG. 3 and it will be understood that the number of GPS systems is not limited.

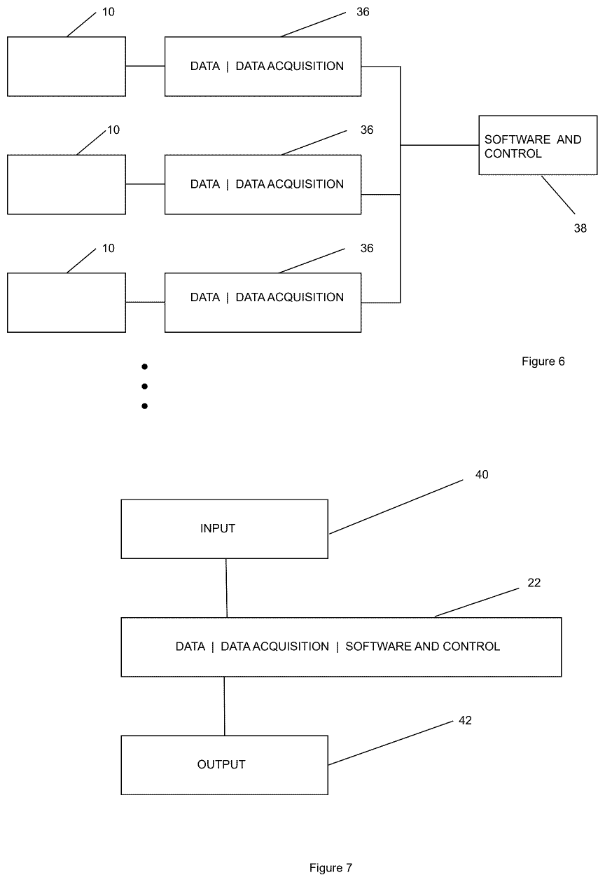

Similarly, FIG. 6 shows a field of at least three GPS systems 10 and associated data and data acquisition modules 36 coupled to one software and/or control system module 38. The configuration is similar to FIG. 4 and it will be understood that the number of GPS systems and component modules are not limited.

FIG. 7 is a simplified block diagram depiction of the endless uses of the systems disclosed herein. The input block 40 represents any of the data and/or data acquisition examples discussed (infra) herein. That input is processed via the control system 22 which results in any number of the desired outputs discussed herein (infra) and represented by the output block 42.

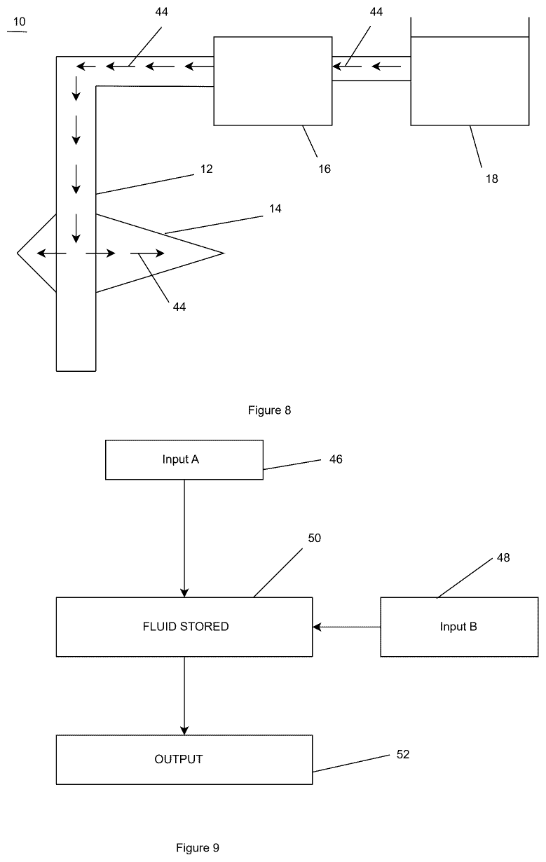

FIG. 8 includes a fluid flow path 44 from the surface tank 18 to the surface facility 16, which includes a pump, down the wellbore 12 and out into the subterranean zone 14. Pumps are used to inject the working fluid and its chemical constituents through the surface piping, down the well and into one or more subterranean zones. The energy used to run the pump is tracked and recorded. The energy input into a geomechanical energy storage system is tracked, the data is captured and recorded. Early testing of the surface and subsurface equipment including the pumps is performed to benchmark the amount of energy required to charge up the subterranean zone and establish how much energy can be stored and for how long. These models provide the ability to determine how much energy is stored, how much can be extracted, how much can be added, etc.

Geothermal heat gathering during fluid cycle testing completed in the early part of the system construction is used to build mathematical models to predict the amount of heat energy that the working fluid can gather from the subterranean zone based on chemical content, soak time, cycle time, flow rate, bottom hole temperature, and the fluid surface temperature. The depth of the subterranean zone and the injection pressure are also used to track the energy stored in the subterranean zone.

Fluid losses from the subterranean zone are calculated and tracked. Data acquisition methods are used to measure pressure, temperature, flow rate, and fluid composition. All of this information is used as an input to the software and control system. The software can determine the amount of energy input into the system, the amount of energy output available at any time, and the amount of usable work that can be performed at the surface at any time. The usable work can include converting fluid pressure to electricity. The software and control system can display a dashboard, informing the users on the amount of energy input into the system, the amount of energy stored lost, the amount of energy stored in the system and the amount of usable work the system can perform at the surface.

The software and control system 22 includes the ability to use direct and indirect measurements such as those gathered with tiltmeters, seismic, InSAR data and the like to track changes, and adjust energy storage estimates. The method of using a software and control system 22 to determine how much energy is stored in the subterranean zone(s), how much can be added, and how much usable work can be performed at the surface with the stored energy. The energy is stored as a high-pressure working fluid in one or more subterranean zones 14. The software and control system 22 is used to track and record the energy used to pump the high pressure working fluid into the subterranean zone(s) 14 and the temperature, pressure, flow rate, chemical composition, of the working fluid and other parameters like the temperature of the subterranean zone. Other indirect measurements are made and recorded such as rock strain, tiltmeters, seismic, InSAR, and others to assist with the calculation of the total energy stored at any point in time. The software and control system 22 collects and records data 24 and uses an algorithm to calculate each part of this equation. Early testing of the geomechanical energy storage system is an opportunity to collect data and build mathematical models for total energy storage plus the geothermal energy gathered by the working fluid while it is in the subterranean zone 14 and the well 12. As the working fluid is cycled into and out of the subterranean zone(s) the mathematical models are revised. After the surface facilities 16 are in place useable work can be performed at the surface, data is captured, and the mathematical models are further enhanced to include energy output and system losses. After several working fluid cycles into and out of the subterranean zones, the geothermal heat gathering component can be further refined. It varies with the variations in the working fluid chemical content, soak time, cycle time, flow rate, bottom hole temperature, and the fluid surface temperature. If more than one subterranean zone 14 is used there may be different heat energy gain rates as the zones will likely be at different depth and have different temperatures. Different subterranean zones may have different rock properties and different leak off rates which reduce the amount of energy storage and thus the amount of usable work that can be performed at the surface.

The software 28 can determine the amount of energy input into the system, the amount of energy output available at any time, and the amount of usable work that can be performed at the surface at any time. The usable work can include converting fluid pressure to electricity. The software and control system 22 can display a dashboard, informing the users on the amount of energy input into the system, the amount of energy stored in the system and the amount of usable work the system can perform at the surface. The maximum amount of energy that can be stored at acceptable loss levels are determined in pre-commissioning trials. This information is used to calibrate mathematical models so that the determination can be made about the energy stored.

The software and control system 22 can solve for this equation at any time. Energy available to perform usable work at the surface=energy stored+geothermal energy gain-energy loss. Equation without losses energy stored=fluid energy pumped in+geothermal energy. Each time the working fluid moves the system has some energy loss. Equation with losses energy stored=energy input-energy loss+geothermal energy. Energy available at the surface=energy stored in the subterranean zone+geothermal energy-energy loss. Each step of the previous equation is tracked, recorded, calculated, and/or estimated by the software and control system.

FIG. 9 depicts multiple energy inputs. Fluid pumped into the subterranean zone 14 is an input 46 and the geothermal energy gathered 48 as well as the energy stored under pressure 50 in the subterranean zone is another input. The energy output 52 in the warm, high pressure fluid available at the surface to perform usable work such as to generate electricity. The elasticity of the rock and overburden of the earth keep the warm, high-pressure fluid under pressure as stored energy. Energy use for pumping the fluid into the subterranean well bore is monitored and recorded. The geothermal energy estimates are made by tracking, gathering data, and estimating the heat transferred to the working fluid.

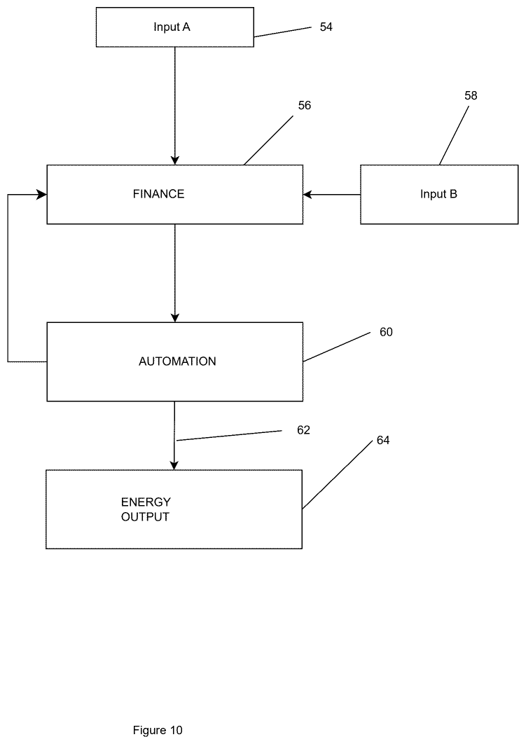

FIG. 10 includes an energy storage module input 54 of the software control system 22, the finance module 56 which receives external source inputs 58 from schedules, rates, terms, condition, agreements, and the like. The finance module 56 sends output to an automation module 60 and also gets feedback from the automation module 60. Also included is the communication link 62 from the automation module 60 to associated energy output mechanisms 62 which may include, for example, solenoid operated valves and the like which allow energy to be transmitted to the surface equipment and out of the system.

The software and control system 22 can predict all financial details for the high-pressure fluid, geomechanical, subterranean energy storage system-inject when energy is low cost, store it, produce fluid and usable work when the demand is high. This system is unique in that it will use geomechanical energy storage with high pressure fluid stored in one or more subterranean zones, data, and software control methods. The principal purpose of any energy storage system is to store energy until it is needed to perform some useful work when it is needed. A geomechanical energy storage system does this function on a very large scale. If multiple subterranean zones and/or multiple wellbores are connected to one or more data acquisition, software and control systems 22 the energy storage and delivery get much, much bigger. Since the cost of these activities can be very large the software and control system must include features to control cost for energy consumed, energy lost through friction, operating the computers, lights, displays, shop equipment, data acquisition equipment and all associated overhead costs. The software and control system 22 includes the ability to control and predict the schedule or direct activity for using energy to inject fluid into one or more subterranean zones, how long to hold it, and when to release it to the surface to perform usable work. If electricity is generated at the surface and fed into the grid the software and control system can perform automated billing operations. It can calculate operating cost, energy consumption cost, and profit for any and all parts of the system.

Utilities operate with schedules, rates, and other terms and conditions. Electricity providers and large-scale consumers may also utilize and communicate these and other parameters as part of business agreements. Each geomechanical energy storage system 20 that contains enough storage capacity can participate at this level. The software and control system 22 can assist with these tasks and feed the automation module to operate the system automatically.

Ideally, low-cost energy will be stored, held and later released at a time when need and price are favorable to generate sufficient return on investment. Since the software and control system 22 is scalable it can perform the same functions for a single geomechanical energy storage system with one subterranean zone, one well, and one set of surface equipment or multiple subsystems, with multiple subterranean zones and/or wellbores in any quantity or combination. The software and control system 22 can make charge and discharge decisions for the geomechanical energy storage system(s) based on financial calculations as well as total fluid volume stored, and total energy volume stored. The financial module of the software and control system will make charge and discharge decisions and the automation module will execute the tasks necessary to release the high pressure fluid energy stored in the subterranean zone to the surface to perform useful work at the rate needed for the duration needed.

The break even cost and the profit is tracked and calculated by the software and control system 22. The working fluid and its chemical constituents are pumped into the subterranean storage zone 14 when low-cost power is available, then ideally the stored energy is released the high pressure fluid moves from the subterranean zone 14, up the well bore 12 to the surface facility 16 where fluid pressure is converted to usable work which may include generating electricity. If “green energy” electricity is available and at a low enough cost, it may be used to pump the working fluid into subterranean zone in order to store energy utilizing the elasticity of the rock and overburden of the earth to maintain the working fluid under pressure.

The software and control system 22 includes features to track the energy stored and the energy available to perform usable work. It also includes features to calculate the cost associated with the energy used by the system to pump the fluid into the subterranean zone, the energy lost while performing this task, the cost of storing the energy in the subterranean zone, and the cost of performing the usable work at the surface the sales price of the electricity generated. The finance part of the software and control system 22 can perform automated billing including calculating the electricity generated, writing an invoice and send the information to the appropriate party.

All system inputs (54, 58), all data, all calculation routines, schedules, and estimates are available as inputs into the financial software and control section. Its outputs may include, but are not limited to a)the profit, loss, overhead cost, energy cost, buy/sell timing, and billing for any system or subsystem. The financial module 56 of the software and control system feeds information to the automation module 60 of the software and control system for energy output 64. All system data is available plus the scheduled, rates, scheduled rate predictions, for energy suppliers, as well as the output section contains automated billing and display the calculated cost and profit, predict, calculate what happened in the last cycle estimate, calculate, predict, generate, display inputs costs, volume, energy used, energy consumed, energy lost, energy stored, cost of storing the energy, energy available for performing usable work at the surface.

The automation module 60 of the software and control system has three modes of operation to control output of the geomechanical energy storage system(s) based on inputs include but are not limited to instructions from the finance module 56, energy stored information, financial module outputs, grid conditions, load, voltage, frequency and electrical demand. Features include three modes complete automation, partial automation, or manual override.

By way of example, the energy storage module sends a note to the finance module 56 that states the energy storage level is high. The finance module 56 continuously monitors input from the energy storage module and the automation module 60, which is also monitoring the grid. In this example the automation module 60 senses a larger demand from the grid and notifies the finance module 56 which gives the OK to the automation module 60 to produce electricity. The automation module 60 starts those processes and sends feedback. The automation module 60 continues to monitor all the processes, data, and flags high or low limits.

By further example, the automation module 60 produces electricity until the electrical grid demand drops. Then the automation module 60 stops producing electricity and notifies the finance module 56, which now start the process of finding, defining and looking for a schedule to a) recharge, b) hold, or c) tell the automation module 60 to start again. If the automation module 60 senses low load it notifies the finance module 56 and electricity generation can start again.

Finance module 56 controls forecasted scheduling and the automation module 60 senses electrical load and demand. It asks permission from the finance module 56 for permission to continue if the electric load drops and the need arises to release stored energy to send electricity to the grid. The automation module 60 may contain multiple modes. One may be a pre-determined schedule and another may be to wait with at least a partially charged system to produce electricity when needed. Back and forth communication happens between the finance module 56 and the fully automated mode based on the monitoring of the electricity demand.

The automation module 60 of the software and control system 22 may have three modes of operation to control output of the geomechanical energy storage system(s) based on inputs including, energy stored, financial module outputs, grid conditions, load, voltage, and frequency. The subsystems include sequenced wells, subterranean zones, and one or more surface production facilities. These modes of operation may include: complete automation, partial automation, or manual over ride. Additionally, the module may run some self-diagnostic functions, tracking losses during pumping, losses during energy storage, and losses while moving fluid from the subterranean zone(s) to the surface to perform usable work.

In full automation mode, the software and control system 22 monitors all inputs and makes decisions based on pre programmed conditions. In semi automated mode, the software and control system 22 and the human operator(s) monitor energy levels and output needs and the measured values, and make charge, discharge, or hold decisions. In full manual mode, the software and control system 22 only displays information but does not allow fluid movement allowing the human(s) do that by sending signals to the electronic or by manually manipulating valves.

Full automated mode can be adjusted to maximize hold time, financial gain, or reduce need for different methods of electricity production that are closely regulated (i.e., hydrocabons) that are consumed to produce electricity. The software and control system 22 that can predict, monitor, and control energy inputs and outputs utilizing high-pressure working fluid in a subterranean formation to store energy that can be released, flow to the surface to perform useful work such as produce electricity. The software and control system 22 can be pre programmed to maximize usefulness by balancing grid load levels, monitoring grid frequency of the alternating current (AC), predicting need based on learned models from historical data, etc.

These are only exemplary systems, and those of ordinary skill in the art of geotechnical grouting, conformance control, water shut-off, lost circulation materials, among others, may be aware of many similar and complementary systems, materials and approaches which may be substituted for these exemplary systems.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention in its broader aspects, and, therefore, the aim in the appended claims is to cover all such changes and modifications as fall within the true spirit and scope of the present disclosure.

What is claimed is:

1. A system for operating energy stored using high-pressure fluid in a subterranean zone, the system comprising:
a subterranean zone adapted to receive and retain said fluid within a generally sealed formation;
a working fluid storage mechanism to supply said fluid to said zone;
a facility to pump and retain said fluid from said storage to said zone under high pressure and said facility further to convert the high-pressure fluid into usable work;
a data acquisition module for obtaining system data; and
a software module for receiving said data and calculating an amount of energy stored from said high-pressure fluid retained in said zone, said software module further calculating an amount of extractable energy from said system.

2. The system as defined in claim 1 wherein said software module further calculates an amount of additional energy retainable by said zone.

3. The system as defined in claim 1 wherein said extractable energy is the result of the amount of system energy stored after an amount of system energy lost.

4. The system as defined in claim 1 further including a financial module for receiving external inputs and determining system monetary values.

5. The system as defined in claim 4 further including an automation module for automating said operation based upon predetermined conditions.

6. The system as defined in claim 5 wherein said automation module is semi-automated.

7. The system as defined in claim 5 wherein said conditions are financial conditions.

8. The system as defined in claim 5 wherein said conditions are electrical grid conditions.

9. A method for operating energy stored using high-pressure fluid in a subterranean zone, the method comprising:
adapting a subterranean zone to receive and retain said fluid within a generally sealed formation;
supplying said fluid from a working fluid storage mechanism;
pumping and retaining said fluid from said storage to said zone;
obtaining system data from a data acquisition module;
calculating an amount of energy stored in said zone;
calculating an amount of extractable energy from said system;
releasing said high-pressure fluid into energy; and
converting said extractable energy to usable work.

10. The method as defined in claim 9 further calculating an amount of additional energy retainable by said zone.

11. The method as defined in claim 9 further determining system monetary values from a financial module receiving external inputs.

12. The method as defined in claim 9 further automating the convertion based upon predetermined conditions.

13. The method as defined in claim 12 wherein said conditions are financial conditions.

14. The method as defined in claim 12 wherein said conditions are electrical grid
conditions.

15. A module for operating energy stored using high-pressure fluid in a subterranean zone, the module comprising:
a data acquisition member for obtaining data from said zone, said fluid, and a pumping facility;
a software member for receiving said data and calculating an amount of energy stored from said high-pressure fluid retained in said zone, said software member further calculating an amount of extractable energy from said system.

16. The module as defined in claim 15 wherein said software module further calculates an amount of additional energy retainable by said zone.

17. The module as defined in claim 15 further including a financial module for receiving external inputs and determining system monetary values.

18. The module as defined in claim 17 further including an automation member for automating said operation based upon predetermined conditions.

19. The module as defined in claim 18 wherein said automation member is semi-automated.

20. The module as defined in claim 18 wherein said conditions are electrical grid conditions.
